(19) United States
(12) Patent Application Publication
(10) Pub. No.: US 2023/0395849 A1
(43) Pub. Date: Dec. 7, 2023

(54) BATTERY WITH PASSIVE FIRE SUPPRESSION CAPABILITIES

(71) Applicant: GM GLOBAL TECHNOLOGY OPERATIONS LLC, Detroit, MI (US)

(72) Inventors: Thomas J. CHAPATON, Sterling Heights, MI (US); Nicholas Paul William PIECZONKA, Windsor (CA); Ratandeep Singh KUKREJA, Auburn Hills, MI (US)

(73) Assignee: GM GLOBAL TECHNOLOGY OPERATIONS LLC, Detroit, MI (US)

(21) Appl. No.: 17/833,501

(22) Filed: Jun. 6, 2022

(51) Int. Cl. H01M 10/0566; H01M 50/581; H01M 50/24; H01M 50/209

(52) U.S. Cl. CPC H01M 10/0566; H01M 50/581; H01M 50/24; H01M 50/209; H01M 2220/20; H01M 2200/10

(57) ABSTRACT

A battery with passive fire suppression capabilities includes a housing, a battery cell stack disposed within an interior of the housing, and a fire suppression material disposed within the interior of the housing. The battery cell stack includes a plurality of battery cells, with each of the plurality of battery cells including a nonaqueous electrolyte. When the fire suppression material is exposed to the nonaqueous electrolyte, the fire suppression material is configured to retain the nonaqueous electrolyte within the interior of the housing.

### INTRODUCTION

This section provides background information related to the present disclosure which is not necessarily prior art.

The present disclosure relates to housings for batteries and, more particularly, to housings for batteries that include fire suppression materials configured to prevent or inhibit thermal runaway propagation between adjacent battery cells of a battery cell stack disposed within the housing.

A battery is a device that converts chemical energy into electrical energy by means of electrochemical reduction-oxidation (redox) reactions. In secondary or rechargeable batteries, these electrochemical reactions are reversible, which allows the batteries to undergo multiple charging and discharge cycles. Electric vehicles, including hybrid electric vehicles, are powered by electric motors or generators that, in turn, are typically powered by onboard rechargeable batteries. Such batteries typically include multiple individual electrochemical cells (referred to herein as battery cells) arranged in series and/or parallel and positioned adjacent one another to form battery modules and/or battery packs that, when incorporated in a battery system of an electric vehicle, provide the vehicle with a combination of high voltage and high capacity.

Rechargeable batteries employed in electric vehicles internally generate heat under normal charging and discharge operations. To optimize the performance and life of such batteries, it is beneficial to implement cooling systems that can effectively transfer heat away from the battery cells during operation to maintain the temperature of the battery cells within a desirable operating temperature range. When a battery cell is subjected to certain abusive operating or charging conditions, or if a battery cell is manufactured with certain defects, the battery cell may generate a greater amount of heat than can be effectively removed from the battery cell by the cooling system, which may cause the battery cell to enter a condition referred to as thermal runaway. During a thermal runaway event, the heat generated by the battery cell may be unbounded and may, in turn, cause adjacent battery cells to enter thermal runaway, potentially initiating a cascading reaction that may spread through an entire battery system. In addition, battery cells undergoing thermal runaway may release hot effluent gases, sometimes near other components of the battery system, which may be negatively impacted by the temperature and/or composition of the effluent gases. For example, rechargeable batteries oftentimes include a nonaqueous liquid electrolyte that provides an ionically conductive pathway between opposite electrodes of a battery cell. However, such nonaqueous liquid electrolytes may include flammable volatile organic compounds, which may leak from the batteries during a thermal runaway event and/or due to physical damage to the battery cells.

To prevent thermal runaway propagation between adjacent battery cells, thermal barriers may be positioned between groups of battery cells to contain the heat generated during a thermal runaway event to a small group of battery cells. To prevent accumulation of effluent gases, and to protect battery system components from exposure to such gases, battery housings may include a venting system configured to direct and control the flow of effluent gases through and out of the battery system.

### SUMMARY

This section provides a general summary of the disclosure and is not a comprehensive disclosure of its full scope or all of its features.

The present disclosure relates to a battery with passive fire suppression capabilities. The battery comprises a housing, a battery cell stack disposed within the housing, and a fire suppression material disposed within the housing. The housing including a top, a bottom, and a sidewall that at least partially define an interior of the housing. The battery cell stack includes a plurality of battery cells disposed within the interior of the housing. Each of the plurality of battery cells includes a nonaqueous electrolyte. The fire suppression material is disposed within the interior of the housing, between the battery cell stack and at least one of the top, the bottom, and the sidewall of the housing. When the fire suppression material is exposed to the nonaqueous electrolyte, the fire suppression material is configured to retain the nonaqueous electrolyte within the interior of the housing.

The fire suppression material may be configured to retain liquids or gases of the nonaqueous electrolyte within the interior of the housing.

Each of the plurality of battery cells may include a sealed case and an electrode assembly sealed within a case. The nonaqueous electrolyte of each of the plurality of battery cells may be sealed within the case and may infiltrate one or more components of the electrode assembly. In such case, the fire suppression material may be disposed outside of the sealed cases of the plurality of battery cells, between the sealed cases of the plurality of battery cells and at least one of the top, the bottom, and the sidewall of the housing.

When the fire suppression material is exposed to the nonaqueous electrolyte, the fire suppression material may be configured to encapsulate the battery cell stack within the interior of the housing.

When the fire suppression material is exposed to the nonaqueous electrolyte, the fire suppression material may be configured to form a thermally and electrically insulating physical barrier around the battery cell stack that inhibits gases of the nonaqueous electrolyte from escaping the interior of the housing.

The fire suppression material may be an intumescent material. In such case, when the fire suppression material is exposed to thermal runaway temperatures, the fire suppression material may be configured to expand and fill-in flow-through passages within the housing between the battery cell stack and at least one of the top, the bottom, and the sidewall of the housing.

The intumescent material may be applied to inner surfaces of at least one of the top, the bottom, and the sidewall of the housing.

The fire suppression material may be a silicone foam. In such case, when the fire suppression material is exposed to thermal runaway temperatures, the fire suppression material may thermally decompose to silicon dioxide (SiO₂).

The fire suppression material may have a porous structure. In such case, when the fire suppression material is exposed to the nonaqueous electrolyte, the fire suppression material may be configured to mechanically entrap, adsorb, or absorb the nonaqueous electrolyte within its porous structure.

In some aspects, the fire suppression material may be disposed within the interior of the housing between the battery cell stack and the bottom of the housing. For example, the fire suppression material may be disposed within a container underneath the battery cell stack, between the battery cell stack and the bottom of the housing. The container may be constructed and arranged to collect and contain liquids of the nonaqueous electrolyte released from the battery cell stack.

The fire suppression material may comprise calcium carbonate (CaCO₃).

The fire suppression material may be configured to chemically decompose when exposed to liquids of the nonaqueous electrolyte to release carbon dioxide gas.

The fire suppression material may be configured to thermally decompose when exposed to thermal runaway temperatures to release carbon dioxide gas.

A method of manufacturing a battery with passive fire suppression capabilities is disclosed. In the method, a fire suppression material is applied to inner surfaces of a component of a battery housing. The component is at least one of a top, a bottom, and a sidewall of the battery housing. At least a portion of the battery housing is assembled such that the fire suppression material is disposed within an interior of the housing. A battery cell stack is positioned within the interior of the housing such that the fire suppression material faces toward the battery cell stack.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a schematic perspective view of a battery including a battery cell stack disposed within a housing, the battery cell stack including a plurality of battery cells and two partitions sandwiched between adjacent battery cells that divide the battery cells of the battery cell stack into first, second, and third groups of battery cells.

FIG. 2 is a schematic perspective view of an electric vehicle including the battery of FIG. 1.

FIG. 3 is a schematic side cross-sectional view of the battery of FIG. 1.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent on a weight percentage (%) basis. This may include compositions or materials having, by weight, greater than 50% X, as well as those having, by weight, less than 50% X, so long as X is the single largest constituent of the composition or material.

The term “battery” means a device that includes multiple interconnected electrochemical cells (battery cells) arranged in series and/or parallel and may refer to battery cells that are grouped together in the form of battery modules and/or battery packs.

Example embodiments will now be described more fully with reference to the accompanying drawings.

The present disclosure relates to housings for batteries that include passive fire suppression capabilities. In practice, a battery cell stack including a plurality of battery cells may be disposed within an interior of a housing. Each of the plurality of battery cells may include a nonaqueous electrolyte. A fire suppression material is disposed within the interior of the housing, between the battery cell stack and a top, bottom, and/or sidewall of the housing. During a thermal runaway event and/or in situations where one or more of the battery cells of the battery cell stack are damaged, nonaqueous electrolyte may be released from the battery cell stack. In such case, when the fire suppression material is exposed to the nonaqueous electrolyte or to thermal runaway conditions, the fire suppression material is configured to retain the nonaqueous electrolyte released from the battery cell stack within the interior of the housing.

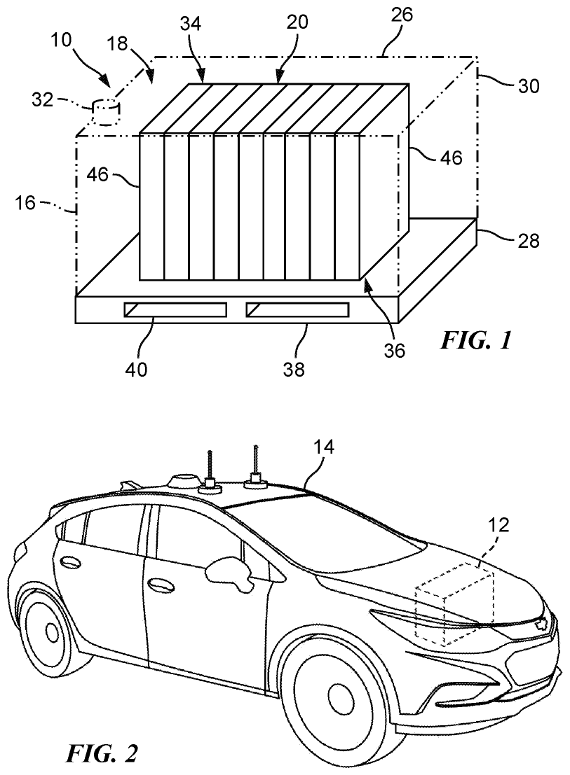

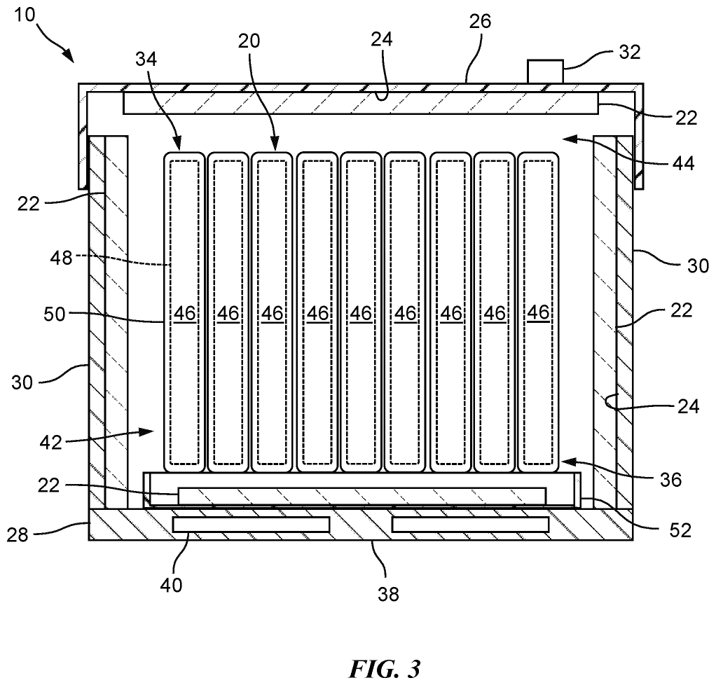

FIG. 1 depicts a battery 10 that may be used in an electric power supply 12 of a vehicle 14, such as an electric vehicle (EV) or a hybrid electric vehicle (HEV), as shown in FIG. 2. The battery 10 includes a housing 16 that at least partially defines an interior 18 and a battery cell stack 20 disposed within the interior 18 of the housing 16. A fire suppression material 22 (FIG. 3) is disposed within the interior 18 of the housing 16, between an inner surface 24 of the housing 16 and the battery cell stack 20.

The housing 16 is configured to support the battery cell stack 20 within the vehicle 14 and to protect the battery cell stack 20 from exposure to ambient environmental conditions. The housing 16 may include a top 26, a bottom 28, and at least one sidewall 30 extending between the top 26 and the bottom 28 of the housing 16. In aspects, a vent 32 may be in the top 26 of the housing 16 that facilitates pressure-induced venting of gas from the interior 18 of the housing 16. The housing 16 may be made of a thermally conductive material to allow heat to dissipate away from the battery cell stack 20 during operation. The housing 16 may be made of a metal, metal alloy, or a polymeric material having high thermal conductivity. For example, the housing 16 may be made of aluminum (Al) and/or copper (Cu). The housing 16 may be an assembly of multiple components or may be of unitary one-piece construction.

The battery cell stack 20 includes an upper end 34 adjacent the top 26 of the housing 16 and a lower end 36 supported on and in thermal contact with the bottom 28 of the housing 16. The bottom 28 of the housing 16 may be in thermal contact with a heatsink 38 that transfers thermal energy (i.e., heat) away from the battery cell stack 20 to a heat transfer fluid (e.g., air or a liquid coolant) during operation of the battery 10. The heatsink 38 may include one or more passageways 40 that facilitate a continuous flow of the heat transfer fluid through the heatsink 38 during operation of the battery 10. In aspects, the heatsink 38 may be defined by the bottom 28 of the housing 16. The battery cell stack 20 is disposed within the interior 18 of the housing 16 such that the battery cell stack 20 is spaced-apart from at least one of the top 26, the bottom 28, or the sidewall 30 of the housing 16. For example, as best shown in FIG. 3, the battery cell stack 20 may be disposed within the interior 18 of the housing 16 such that a gap 42 is defined between the sidewall 30 of the housing 16 and the battery cell stack 20. As best shown in FIG. 3, the battery cell stack 20 may be disposed within the interior 18 of the housing 16 such that another gap or plenum 44 is defined between the top 26 of the housing 16 and the upper end 34 of the battery cell stack 20.

The battery cell stack 20 includes a plurality of battery cells 44 arranged side-by-side within the battery cell stack 20. Each of the battery cells 46 in the battery cell stack 20 includes an electrode assembly 48 (including a separator sandwiched between a positive electrode and a negative electrode) infiltrated with a nonaqueous electrolyte (not shown) and sealed within a case 50 (FIG. 3). The battery cells 46 may be lithium-ion battery cells. For example, as shown in FIG. 3, the battery cells 46 may be pouch-type lithium-ion battery cells. In other aspects, the battery cells 46 may be prismatic or can-type lithium-ion battery cells.

The nonaqueous electrolyte sealed within the case 50 of each of the battery cells 46 may be in the form of a liquid or a solid and may comprise one or more organic solvents or other organic chemical compounds that may be classified as volatile organic compounds (VOCs). The term “volatile organic compounds” refers to organic compounds that exhibit a high vapor pressure at room temperature and a relatively low boiling point, e.g., an initial boiling point of less than or equal to about 250° C. at standard atmospheric pressure (1 Atm). For example, volatile organic compounds may exhibit an initial boiling point of greater than or equal to about 50° C. to less than or equal to about 250° C. at standard atmospheric pressure. The volatile organic compounds in the battery cells 46 may be relatively flammable and, during a thermal runaway event and/or in the event of damage to one or more of the battery cells 46, volatile organic compounds released from the battery cells 46 may increase the potential of a fire and/or the spread of a fire in the battery 10 and the vehicle 14.

The fire suppression material 22 is configured to help retain volatile organic compounds released from the battery cells 46 within the interior 18 of the housing 16 to help suppress or inhibit the generation of fire and/or propagation or spread of fire from the battery 10 to the vehicle 14. The fire suppression capabilities of the fire suppression material 22 may be passive, meaning that the fire suppression capabilities of the fire suppression material 22 may be activated in response to certain conditions within the housing 16 of the battery 10. For example, the fire suppression capabilities of the fire suppression material 22 may be activated when the fire suppression material 22 is exposed to certain thermal runaway conditions, e.g., thermal runaway temperatures greater than or equal to about 170° C., about 250° C., or about 400° C. Additionally or alternatively, the fire suppression capabilities of the fire suppression material 22 may be activated when the fire suppression material 22 is exposed to gases or liquids of volatile organic compounds released from the battery cells 46.

As shown in FIG. 3, in some aspects, the fire suppression material 22 may be disposed within the interior 18 of the housing 16, for example, by being disposed along the inner surfaces 24 of the top 26, bottom 28, and/or sidewall 30 of the housing 16. For example, the fire suppression material 22 may be disposed along the inner surface 24 of the top 26 of the housing 16 and thus may be located within the plenum 44 that extends between the top 26 of the housing 16 and the upper end 34 of the battery cell stack 20. Additionally or alternatively, the fire suppression material 22 may be disposed along the inner surface 24 of the sidewall 30 of the housing 16 and thus may be located within the gap 42 between the sidewall 30 of the housing 16 and the battery cell stack 20. In some aspects, the fire suppression material 22 may be disposed along the inner surfaces 24 of the top 26, bottom 28, and/or sidewall 30 of the housing 16, for example, by being applied or coated onto the inner surfaces 24 of the top 26, bottom 28, and/or sidewall 30 of the housing 16.

In some aspects, when the fire suppression material 22 is activated, for example, upon exposure to thermal runaway temperatures and/or to gases or liquids of the nonaqueous electrolyte released from the battery cells 46, the fire suppression material 22 may be configured to form a thermally and electrically insulating physical barrier around the battery cell stack 20 that inhibits gases and/or liquids of the nonaqueous electrolyte from escaping the interior 18 of the housing 16. In some aspects, when activated, the fire suppression material 22 may be configured to encapsulate the battery cell stack 20 and/or to expand and fill-in flow-through passages in the housing 16 through which gases and/or liquids of the nonaqueous electrolyte could be released from the interior 18 of the housing 16 to a surrounding environment outside the housing 16 (e.g., to the interior of the vehicle 14).

In some aspects, the fire suppression material 22 may comprise an intumescent material, expanding foam, or encapsulating material that, upon exposure to thermal runaway temperatures, will expand and thereby create a seal around the battery cell stack 20 such that gases and/or liquids of the nonaqueous electrolyte released from the battery cell stack 20 will be retained in the interior 18 of the housing 16. In addition, upon exposure to thermal runaway temperatures, the fire suppression material 22 may expand and fill the plenum 44 between the top 26 of the housing 16 and the upper end 34 of the battery cell stack 20 and/or may fill the gap 42 between the sidewall 30 of the housing 16 and the battery cell stack 20. By filling-in the plenum 44 and/or the gap 42 between the battery cell stack 20 and the housing 16, the fire suppression material 22 may effectively limit the amount of oxygen in the housing 16 and thereby prevent or inhibit the initiation or propagation of combustion reactions (e.g., fire). In addition, by filling-in the plenum 44 and/or the gap 42 between the battery cell stack 20 and the housing 16, the fire suppression material 22 may prevent or inhibit the release of gases and/or liquids of the nonaqueous electrolyte from the battery cell stack 20 and/or from the interior 18 of the housing 16 to a surrounding environment outside the housing 16.

In some aspects, the fire suppression material 22 may be made of a thermally and/or electrically insulative material, which may help prevent the propagation of thermal runaway temperatures through the battery cells 46 of the battery cell stack 20 and/or from the battery 10 to the vehicle 14.

Examples of intumescent materials, expanding foams, and/or encapsulating materials include FV060 Ventilated Façade Cavity Closer manufactured by Tremco CPG UK Limited and FIRE POLY FPCC Clear Fire Retardant Coating manufactured by Flame Safe Chemical Corporation.

In some aspects, the fire suppression material 22 may comprise a silicon foam. In such case, when the fire suppression material 22 is exposed to certain thermal runaway temperatures, the fire suppression material 22 may thermally decompose to inorganic silicon dioxide (SiO₂), which may create a protective layer on the inner surfaces 24 of the top 26, bottom 28, and/or sidewall 30 of the housing 16 that isolates housing 16 from fire and inhibits exchanges of mass and energy.

In some aspects, the fire suppression material 22 may comprise a porous non-transition metal oxide or carbonate. For example, the fire suppression material 22 may comprise an oxide or carbonate of an alkali metal (e.g., Na and/or K), an alkaline earth metal (e.g., Mg and/or Ca), or a metalloid (e.g., Si and/or B). In such case, when the fire suppression material 22 is exposed to gases and/or liquids of the nonaqueous electrolyte released from the battery cell stack 20, the released gases and/or liquids may be mechanically entrapped, adsorbed, or absorbed by the fire suppression material 22. In aspects where the fire suppression material 22 comprises a carbonate, when the fire suppression material 22 is exposed to liquids of the nonaqueous electrolyte released from the battery cell stack 20, the nonaqueous electrolyte may chemically react with the fire suppression material 22 to release carbon dioxide (CO₂) gas at ambient atmospheric temperature and pressure conditions, which may prevent or inhibit the initiation or propagation of combustion reactions within the interior 18 of the housing 16. In addition, in aspects where the fire suppression material 22 comprises a carbonate, the fire suppression material 22 may thermally decompose and release carbon dioxide (CO₂) gas when exposed to certain thermal runaway temperatures. An example of an alkaline earth metal carbonate is calcium carbonate (CaCO₃), which chemically decomposes upon reaction with acids, releasing carbon dioxide gas. In addition, calcium carbonate thermally decomposes at temperatures greater than or equal to about 650° C. or about 700° C., releasing carbon dioxide gas.

As shown in FIG. 3, in some aspects, the fire suppression material 22 may be disposed within the interior 18 of the housing 16 between the battery cell stack 20 and the bottom 28 of the housing 16. For example, the fire suppression material 22 may be disposed within a container 52 located in the interior 18 of the housing 16 underneath the battery cell stack 20. In such an arrangement, liquids of the nonaqueous electrolyte released from the battery cell stack 20 may be collected in the container 52 underneath the battery cell stack 20 and mechanically entrapped, adsorbed, or absorbed by the fire suppression material 22 disposed within the container 52.

In some aspects, the fire suppression material 22 may be applied to the inner surfaces 24 of the top 26, bottom 28, and/or sidewall 30 of the housing 16 prior to assembly of the battery 10. For example, the fire suppression material 22 may be applied to the inner surfaces 24 of the top 26, bottom 28, and/or sidewall 30 of the housing 16, the housing 16 may be at least partially assembled, and the battery cell stack 20 may be positioned within the interior 18 of the housing 16 such that the fire suppression material 22 faces toward the battery cell stack 20.

The foregoing description of the embodiments has been provided for purposes of illustration and description. It is not intended to be exhaustive or to limit the disclosure. Individual elements or features of a particular embodiment are generally not limited to that embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A battery with passive fire suppression capabilities, the battery comprising:
a housing including a top, a bottom, and a sidewall that at least partially define an interior of the housing;
a battery cell stack including a plurality of battery cells disposed within the interior of the housing, each of the plurality of battery cells including a nonaqueous electrolyte;
a fire suppression material disposed within the interior of the housing, between the battery cell stack and at least one of the top, the bottom, and the sidewall of the housing,
wherein, when the fire suppression material is exposed to the nonaqueous electrolyte, the fire suppression material is configured to retain the nonaqueous electrolyte within the interior of the housing.

2. The battery of claim 1, wherein the fire suppression material is configured to retain liquids or gases of the nonaqueous electrolyte within the interior of the housing.

3. The battery of claim 1, wherein each of the plurality of battery cells includes a sealed case and an electrode assembly sealed within a case, and wherein the nonaqueous electrolyte of each of the plurality of battery cells is sealed within the case and infiltrates one or more components of the electrode assembly.

4. The battery of claim 3, wherein the fire suppression material is disposed outside of the sealed cases of the plurality of battery cells, between the sealed cases of the plurality of battery cells and at least one of the top, the bottom, and the sidewall of the housing.

5. The battery of claim 1, wherein, when the fire suppression material is exposed to the nonaqueous electrolyte, the fire suppression material is configured to encapsulate the battery cell stack within the interior of the housing.

6. The battery of claim 5, wherein, when the fire suppression material is exposed to the nonaqueous electrolyte, the fire suppression material is configured to form a thermally and electrically insulating physical barrier around the battery cell stack that inhibits gases of the nonaqueous electrolyte from escaping the interior of the housing.

7. The battery of claim 5, wherein the fire suppression material is an intumescent material, and wherein, when the fire suppression material is exposed to thermal runaway temperatures, the fire suppression material is configured to expand and fill-in flow-through passages within the housing between the battery cell stack and at least one of the top, the bottom, and the sidewall of the housing.

8. The battery of claim 7, wherein the intumescent material is applied to inner surfaces of at least one of the top, the bottom, and the sidewall of the housing.

9. The battery of claim 1, wherein the fire suppression material is a silicone foam, and wherein, when the fire suppression material is exposed to thermal runaway temperatures, the fire suppression material thermally decomposes to silicon dioxide (SiO₂).

10. The battery of claim 1, wherein the fire suppression material has a porous structure, and wherein, when the fire suppression material is exposed to the nonaqueous electrolyte, the fire suppression material is configured to mechanically entrap, adsorb, or absorb the nonaqueous electrolyte within its porous structure.

11. The battery of claim 10, wherein the fire suppression material is disposed within the interior of the housing between the battery cell stack and the bottom of the housing.

12. The battery of claim 11, wherein the fire suppression material is disposed within a container underneath the battery cell stack, between the battery cell stack and the bottom of the housing, and wherein the container is constructed and arranged to collect and contain liquids of the nonaqueous electrolyte released from the battery cell stack.

13. The battery of claim 11, wherein the fire suppression material comprises calcium carbonate (CaCO₃).

14. The battery of claim 1, wherein the fire suppression material is configured to chemically decompose when exposed to liquids of the nonaqueous electrolyte to release carbon dioxide gas.

15. The battery of claim 1, wherein the fire suppression material is configured to thermally decompose when exposed to thermal runaway temperatures to release carbon dioxide gas.

16. A method of manufacturing a battery with passive fire suppression capabilities, the method comprising:
applying a fire suppression material to inner surfaces of a component of a battery housing, wherein the component is at least one of a top, a bottom, and a sidewall of the battery housing;
assembling at least a portion of the battery housing such that the fire suppression material is disposed within an interior of the housing; and
positioning a battery cell stack within the interior of the housing such that the fire suppression material faces toward the battery cell stack.
